(19) United States
(12) Patent Application Publication
(10) Pub. No.: US 2014/0299651 A1
(43) Pub. Date: Oct. 9, 2014

(54) MOLYBDENUM-BASED FRICTION STIR WELDING TOOLS

(71) Applicants: Tim STOTLER, Columbus, OH (US); John SEAMAN, Columbus, OH (US)

(72) Inventors: Tim STOTLER, Columbus, OH (US); John SEAMAN, Columbus, OH (US)

(73) Assignee: EDISON WELDING INSTITUTE, Columbus, OH (US)

(21) Appl. No.: 14/206,105

(22) Filed: Mar. 12, 2014

Related U.S. Application Data
(60) Provisional application No. 61/777,792, filed on Mar. 12, 2013.

(51) Int. Cl. B23K 20/12

(52) U.S. Cl. CPC B23K 20/1255
USPC 228/2.1

(57) ABSTRACT

A friction stir welding tool includes that a body and a pin formed integrally with the body at one end thereof. The body and pin further include a first material and a second material; wherein the first material further includes a molybdenum-based refractory alloy; and wherein the second material further includes hafnium, lanthanum, carbon, titanium, zirconium, or combinations thereof.

This patent application claims the benefit of U.S. Provisional Patent Application Ser. No. 61/777,792 filed on Mar. 12, 2013 and entitled “Molybdenum-Based Friction Stir Welding Tools,” the disclosure of which is hereby incorporated by reference herein in its entirety and made part of the present U.S. utility patent application for all purposes.

### BACKGROUND OF THE INVENTION

Friction stir welding (FSW) is a known joining process that typically utilizes a rotating welding device having a tool that is inserted into a joint that is rigidly clamped to generate frictional heat and plastic deformation at the joint without consuming the tool itself during the process. The frictional heat combined with heat generated by the mechanical mixing process and the adiabatic heat within the material causes the stirred materials to soften without melting. The softened material (e.g., metal) then bonds using induced mechanical stresses. The result is the formation of a joint while the welded material is in the solid state.

The principal advantages of FSW, being a solid-state process, are low distortion, absence of melt-related defects, and high joint strength, even in those alloys that are considered unweldable with conventional techniques. Importantly, because FSW is a solid-state process, the original material characteristics typically remain substantially unchanged after joint formation has occurred. This aspect of the process is especially useful for large or otherwise unwieldy objects that cannot be easily heat-treated after welding to recover temper characteristics. Additionally, joints produced by FSW do not suffer from filler-induced problems and defects since the process does not utilize filler and does not introduce additional hydrogen into the materials, which is important for steels and other alloys susceptible to hydrogen damage. Furthermore, FSW is a highly flexible technique that is useful for producing butt, corner, lap, T, spot, fillet and hem joints, as well as for welding hollow objects, including tanks, tubes, pipes, stock with variable thickness, tapered sections and parts with three-dimensional contours. FSW can be performed in most or all positions (horizontal, vertical, overhead and orbital), and can create or repair weld joints utilizing equipment that is based on traditional machine tool technologies.

The use of FSW is highly desirable for aerospace and nuclear applications; however, the materials that must be joined for such applications often include hard metals with high melting points, such as nickel, steel, titanium, zirconium and their alloys. Because standard FSW tools made from steel alloys were generally insufficient to work with these hard, high melting point metals, tungsten-based tools were developed for use with nickel, steel, titanium and their alloys. The use of tungsten-based tools for FSW of zirconium and zirconium-based alloys has also been attempted, but with less success. Modified tungsten-based tools, such as tungsten alloyed with rhenium have also been developed, but tungsten-rhenium-based material adheres or galls when welding zirconium, thereby causing the process to become unstable and as a result, the weld-joints are not effectively consolidated. Consequently, there is an ongoing need for FSW tools that include tools that are not tungsten-based and that are effective for joining nickel, steel, titanium and their alloys. There is also an ongoing need for FSW tools that are effective for joining zirconium and zirconium-based alloys.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a friction stir welding system is provided. This system includes a first material to be joined and a second material to be joined, wherein at least one the first and second materials further comprises zirconium or an alloy thereof; and a friction stir welding tool, wherein the friction stir welding tool is operative to join the first material to the second material. The friction stir welding tool further includes a body, and a pin formed integrally with the body at one end thereof; wherein the body and pin further include a first material and a second material; wherein the first material further includes a molybdenum-based refractory alloy; and wherein the second material further includes hafnium, lanthanum, carbon, titanium, zirconium, or combinations thereof.

In accordance with another aspect of the present invention, a tool for use with friction stir welding processes is provided. This friction stir welding tool includes a body, and a pin formed integrally with the body at one end thereof; wherein the body and pin further include a first material and a second material; wherein the first material further includes a molybdenum-based refractory alloy; and wherein the second material further includes hathium, lanthanum, carbon, titanium, zirconium, or combinations thereof.

In yet another aspect of this invention, another tool for use with friction stir welding processes is provided. This friction stir welding includes a body, and a pin formed integrally with the body at one end thereof, wherein the pin includes a round bottom thread configuration; wherein the body and pin further include a first material and a second material; wherein the first material further includes a molybdenum-based refractory alloy; wherein the molybdenum-based refractory alloy further includes a carbide; and wherein the carbide is hafnium, zirconium, tantalum, niobium, or combinations thereof; and wherein the second material further includes hafnium, lanthanum, carbon, titanium, zirconium, or combinations thereof.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 provides a cross-sectional view of an exemplary embodiment of the friction stir welding tool of the present invention, wherein the shoulder region formed between the outer edge of either the body or neck portion of the tool and the outer edge of the base of the pin has been minimized; and

FIGS. 2a-c provide side, top and bottom views respectively of another exemplary embodiment of the friction stir welding tool of the present invention, wherein the pin portion of the tool includes a round bottom thread configuration.

### DETAILED DESCRIPTION OF THE INVENTION

Exemplary embodiments of the present invention are now described with reference to the Figure. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

The present invention relates generally to the use of friction stir welding (FSW) for joining materials having high melting points and hardness, and more specifically to one or more FSW devices that include tools formed from or including molybdenum or at least one molybdenum-based alloy. These molybdenum-based friction stir welding tools provide distinct advantages over tungsten-based prior art devices because: (i) molybdenum-based tools have the potential to be more cost-effective than tungsten-based tools for joining materials such as nickel, steel, and/or alloys thereof, while maintaining comparable joining results; and (ii) molybdenum-based tools permit the joining of materials formed from zirconium and/or zirconium alloys by FSW, wherein tungsten-based prior art tools do not.

An exemplary embodiment of this invention provides a friction stir welding system that includes a first material to be joined and a second material to be joined, wherein at least one of the first and second materials further comprises zirconium or an alloy thereof; and a friction stir welding tool, wherein the friction stir welding tool is operative to join the first material to the second material. The friction stir welding tool further includes a body, and a pin formed integrally with the body at one end thereof; wherein the body and pin further include a first material and a second material; wherein the first material further includes a molybdenum-based refractory alloy; and wherein the second material further includes hathium, lanthanum, carbon, titanium, zirconium, or combinations thereof. The molybdenum content of the molybdenum-based refractory alloy is typically 50 weight percent or greater. The molybdenum-based refractory alloy may further includes a carbide, wherein the carbide is hafnium, zirconium, tantalum, niobium, or combinations thereof. The molybdenum-based refractory alloy may be sintered and hot isostatically pressed processed and may further include about 0.05 to 1.4 weight percent hathium, about 0.05 to 0.15 weight percent carbon, and about 0.0005 weight percent iron, and wherein the remaining portion is molybdenum. The molybdenum-based refractory alloy may be a forged material or an extruded material. A shoulder portion may be formed between the pin and the body, wherein the pin includes a molybdenum-based refractory alloy, and wherein the shoulder portion further includes either a molybdenum-based refractory alloy or a substantially different material with regard to chemical composition, microstructure, and materials processing. Another embodiment of this invention provides a MoHfC friction stir welding tool that includes molybdenum at about 98% (minimum 98 weight percent); hafnium at about 1.15% (acceptable range: about 0.05 to 1.4 weight percent); carbon at about 0.1% (acceptable range: about 0.05-0.15 weight percent); and iron at about 0.005% (acceptable upper limit: 0.01 weight percent).

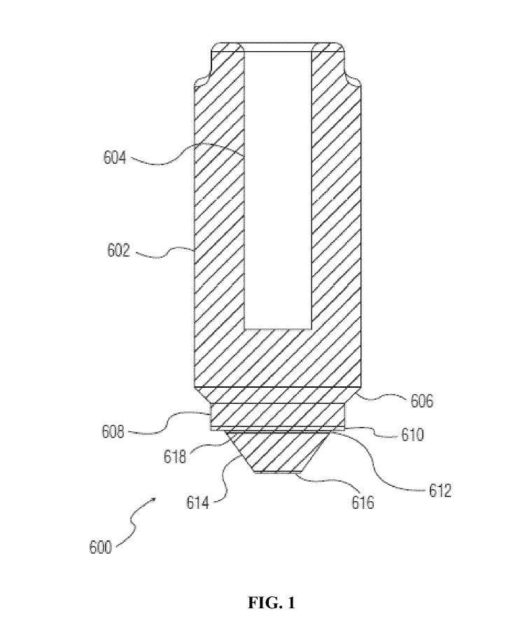

FIG. 1 provides a cross-sectional view of an exemplary embodiment of the friction stir welding tool of the present invention which is suitable for use with metals such as titanium, steel, nickel, and the like, and which includes a “shoulder”. In this embodiment, friction stir welding tool 600 includes a substantially cylindrical body 602, which typically defines a chamber 604 therein. A first frustoconical region 606, which may not be included in some versions of this embodiment, is formed integrally with body 602. A substantially cylindrical neck 608 is formed integrally with first frustoconical region 606. A second frustoconical region 610, which may not be included in some versions of this embodiment, is formed integrally with neck 608. A third frustoconical region 614 is formed integrally with second frustoconical region 610 and functions as the welding pin or probe component of this embodiment. Third frustoconical region 614 includes tip 616 and base 618. The outer edge of base 618 and the outer edge of the neck 608 (or second frustoconical region 610, when it is present) define shoulder region 612 therebetween. The ratio of the outer diameter of the neck to the outer diameter of the base of the probe is within the range of about 1.5:1 to 1.25:1 or less (i.e., approaching but not equaling a ratio of 1:1). In this embodiment, shoulder 612 is minimized to avoid undesirable generation of heat at this surface, which can compromise weld integrity, and to concentrate welding energy in the probe. Shoulder 612 is present in this embodiment to provide positional stability to friction stir welding tool 600 when the device is in use. In other words, shoulder 612 is operative to locate the tool during the welding process and prevent or minimize vibration and “wandering” of the tool. Minimized shoulder 612 is also operative to smooth the surface of the weld and prevent any surface undercut.

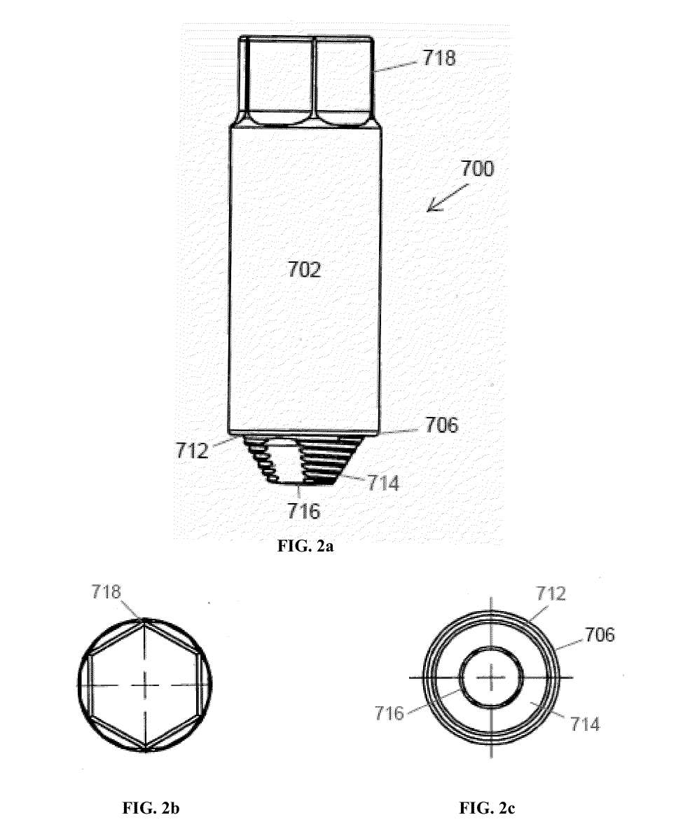

FIGS. 2a-c provide side, top and bottom views respectively of another exemplary embodiment of the friction stir welding tool of the present invention, wherein the pin portion of the tool includes a round bottom thread configuration. In this embodiment, friction stir welding tool 700 shown in FIGS. 2a-c includes a substantially cylindrical body 702. A first frustoconical region 706 is formed integrally with body 702 and a second frustoconical region 714 is formed integrally with first frustoconical region 706. The outer edge of first frustoconical region 706 and the outer edge of the base of second frustoconical region 714 define shoulder region 712 therebetween. Second frustoconical region 714 also includes tip 716 and the region between tip 716 and the base of second frustoconical region 714 is formed as a round bottom thread. A stepped spiral configuration for this region is also possible. The opposite end 718 of friction stir welding tool 700 includes a hexagonal geometry. This embodiment demonstrated very good life, with over 50-in of weld without any wear or deformation. Parameters are nominally 1-3 IPM at 50-100 RPM and 3 degrees of tilt. Welds created with this arrangement had little or no porosity.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1) A friction stir welding system, comprising:
(a) a first material to be joined and a second material to be joined, wherein at least one the first and second materials further comprises zirconium or an alloy thereof; and
(b) a friction stir welding tool, wherein the friction stir welding tool is operative to join the first material to the second material, and wherein the friction stir welding tool further includes:
(i) a body, and a pin formed integrally with the body at one end thereof;
(ii) wherein the body and pin further include a first material and a second material;
(iii) wherein the first material further includes a molybdenum-based refractory alloy; and
(iv) wherein the second material further includes hafnium, lanthanum, carbon, titanium, zirconium, or combinations thereof.

2) The system of claim 1, wherein the molybdenum content of the molybdenum-based refractory alloy is 50 weight percent or greater.

3) The system of claim 1, wherein the molybdenum-based refractory alloy further includes a carbide, and wherein the carbide is hathium, zirconium, tantalum, niobium, or combinations thereof.

4) The system of claim 1, wherein the molybdenum-based refractory alloy is sintered and hot isostatically pressed processed.

5) The system of claim 1, wherein the molybdenum-based refractory alloy further includes about 0.05 to 1.4 weight percent hathium, about 0.05 to 0.15 weight percent carbon, and about 0.0005 weight percent iron, and wherein the remaining portion is molybdenum.

6) The system of claim 1, wherein the molybdenum-based refractory alloy is a forged material.

7) The system of claim 1, wherein the molybdenum-based refractory alloy is an extruded material.

8) The system of claim 1, further comprising a shoulder portion formed between the pin and the body, wherein the pin includes a molybdenum-based refractory alloy, and wherein the shoulder portion further includes either a molybdenum-based refractory alloy or a substantially different material with regard to chemical composition, microstructure, and materials processing.

9) A tool for use with friction stir welding processes, comprising:
(a) a body, and a pin formed integrally with the body at one end thereof;
(b) wherein the body and pin further include a first material and a second material;
(c) wherein the first material further includes a molybdenum-based refractory alloy; and
(d) wherein the second material further includes hafnium, lanthanum, carbon, titanium, zirconium, or combinations thereof.

10) The tool of claim 9, wherein the molybdenum content of the molybdenum-based refractory alloy is 50 weight percent or greater.

11) The tool of claim 9, wherein the molybdenum-based refractory alloy further includes a carbide, and wherein the carbide is hathium, zirconium, tantalum, niobium, or combinations thereof.

12) The tool of claim 9, wherein the molybdenum-based refractory alloy is sintered and hot isostatically pressed processed.

13) The tool of claim 9, wherein the molybdenum-based refractory alloy further includes about 0.05 to 1.4 weight percent hathium, about 0.05 to 0.15 weight percent carbon, and about 0.0005 weight percent iron, and wherein the remaining portion is molybdenum.

14) The tool of claim 9, wherein the molybdenum-based refractory alloy is a forged material.

15) The tool of claim 9, wherein the molybdenum-based refractory alloy is an extruded material.

16) The tool of claim 9, further comprising a shoulder portion formed between the pin and the body, wherein the pin includes a molybdenum-based refractory alloy, and wherein the shoulder portion further includes either a molybdenum-based refractory alloy or a substantially different material with regard to chemical composition, microstructure, and materials processing.

17) The tool of claim 9, wherein the tool is adapted for use with zirconium or alloys thereof.

18) A tool for use with friction stir welding processes, comprising:
(a) a body, and a pin formed integrally with the body at one end thereof, wherein the pin includes a round bottom thread configuration;
(b) wherein the body and pin further include a first material and a second material;
(c) wherein the first material further includes a molybdenum-based refractory alloy; wherein the molybdenum-based refractory alloy further includes a carbide; and wherein the carbide is hafnium, zirconium, tantalum, niobium, or combinations thereof; and
(d) wherein the second material further includes hafnium, lanthanum, carbon, titanium, zirconium, or combinations thereof.

19) The tool of claim 18, wherein the molybdenum content of the molybdenum-based refractory alloy is 50 weight percent or greater.

20) The tool of claim 18, wherein the molybdenum-based refractory alloy is sintered and hot isostatically pressed processed.

21) The tool of claim 18, wherein the molybdenum-based refractory alloy further includes about 0.05 to 1.4 weight percent hathium, about 0.05 to 0.15 weight percent carbon, and about 0.0005 weight percent iron, and wherein the remaining portion is molybdenum.

22) The tool of claim 18, wherein the molybdenum-based refractory alloy is a forged material.

23) The tool of claim 18, wherein the molybdenum-based refractory alloy is an extruded material.

24) The tool of claim 18, further comprising a shoulder portion formed between the pin and the body, wherein the pin includes a molybdenum-based refractory alloy, and wherein the shoulder portion further includes either a molybdenum-based refractory alloy or a substantially different material with regard to chemical composition, microstructure, and materials processing.

25) The tool of claim 18, wherein the tool is adapted for use with zirconium or alloys thereof.
